(19) United States
(12) Patent Application Publication
(10) Pub. No.: US 2022/0226720 A1
(43) Pub. Date: Jul. 21, 2022

(54) Method, System, and Device for Inspection of Scratch-Off Lottery Tickets

(71) Applicant: Christian Michael FROELICH, Lake Forest, IL (US)

(72) Inventor: Christian Michael FROELICH, Lake Forest, IL (US)

(21) Appl. No.: 17/575,825

(22) Filed: Jan. 14, 2022

Related U.S. Application Data
(60) Provisional application No. 63/138,021, filed on Jan. 15, 2021.

(51) Int. Cl. A63F 3/06; G06V 20/62; G06V 30/20; G06V 10/22

(52) U.S. Cl. CPC A63F 3/064; A63F 3/0665; G06V 10/22; G06V 30/20; G06V 20/62

(57) ABSTRACT

A method, system and device for inspection of a lottery ticket uses a device to scan lottery tickets to detect information concerning the amount of scratch-off material, such as a coating or a covering, that has been removed from a ticket, and/or the type, amount, or content of underlying indicia that have been revealed by the scratches. The system may use the information to calculate and set or determine a tolerance level for scratching below which a ticket will not be invalidated, based on parameters that may include the amount of surface area that has been scratched, and/or the type, amount, or content of underlying indicia that has been revealed. The system enables a user to input information to reset the threshold volume to a user-selected volume above which invalidation is triggered.

### CROSS-REFERENCE TO RELATED APPLICATION

The present application claims priority to, and the benefit of the filing date of, U.S. Provisional Patent Application Ser. No. 63/138,021 filed on Jan. 15, 2021, which is incorporated herein by reference in its entirety for all purposes.

### FIELD OF THE INVENTION

The present subject matter relates generally to methods, systems, and devices for point-of-sale inspection, activation, voiding, validation, and payout of instant “scratch-off” type lottery tickets.

### BACKGROUND OF THE INVENTION

Improvements are needed in methods, systems, and devices for point-of-sale inspection, activation, voiding, validation, and payout of instant “scratch-off” type lottery tickets (“instant tickets”). Methods are needed to automate the inspection of tickets to determine if tampering or cheating has occurred, wherein a person has scratched off a sufficient portion of the scratch-off surface to decide that the ticket has value, before purchasing the ticket. Inspection methods, systems, and devices may be better refined in order to efficiently and autonomously assess the integrity of the coating or covering that typically covers the game play surface of instant tickets. Reference is made to U.S. Pat. No. 10,115,265 B2 issued Oct. 30, 2018, the contents of which are incorporated herein by reference in their entirety for all purposes. In particular, reference is made to the descriptions in U.S. Pat. No. 10,115,265 of the features of instant tickets and of inspection processes.

### SUMMARY

Embodiments of the invention include an improved method, system, and device for detecting removal of portions of scratch-off material in the game play area of instant scratch-off type lottery tickets. This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a diagram representing a portion of a game play area of a first scratch-off instant lottery ticket.

FIG. 2 is a diagram representing a portion of a game play area of a second scratch-off instant lottery ticket.

FIG. 3 is a schematic diagram representing method steps and a control system for automated inspection of game play areas of scratch-off instant lottery tickets.

FIG. 4 is a schematic diagram representing method steps and a control system for setting threshold levels of revealed indicia in automated inspection of game play areas of scratch-off instant lottery tickets.

### DETAILED DESCRIPTION OF EMBODIMENTS OF THE INVENTION

The present subject matter relates to the application of machine learning methods, processes, devices, hardware, and/or software to the automated inspection of instant tickets. The game play area of an instant scratch-off lottery ticket may contain game play information that is concealed under a coating before play of the ticket. Typically, the coating is formed of latex or other suitable material that is scratched off by the player to reveal the game play area after the player has purchased the ticket. In most instant tickets, the game play area contains game play data readable by the player after the coating is scratched off, e.g., a set of letters, images, or numerals that must be matched to a winning combination in order for the player to win a prize. Instant tickets may be subject to improper or fraudulent use by a person, who might attempt to reveal whether a ticket is a winning ticket or a losing ticket (before purchase of the ticket) by tampering, e.g., by removing a small amount of scratch-off material in order to reveal game play data.

In addition to intentional scratching for tampering purposes, as described above, instant tickets also often are subject to incidental or unintentional scratching. For example, such unintended scratches may be the result of the process of transporting or loading the instant tickets into sales dispensers. In some circumstances, the incidental or unintentional scratches may reveal the indicia intended to be hidden by the scratch-off coating. In many of those cases, persons selling lottery tickets, such as a retailer, lottery executive, or instant ticket game administrator, may wish to sell such unintentionally-scratched tickets, because, despite the fact that the tickets are scratched and showing portions of the underlying indicia, the portions shown are sufficiently small that players still may not be reasonably enabled to ascertain the value of these tickets. However, if the volume of indicia revealed is such that the buyer may ascertain game play data, such as the prize, that was intended to be fully concealed until after the purchasing and legitimate scratching of the instant ticket, the lottery administrator would likely choose to invalidate such an instant ticket, thereby making it unavailable for sale.

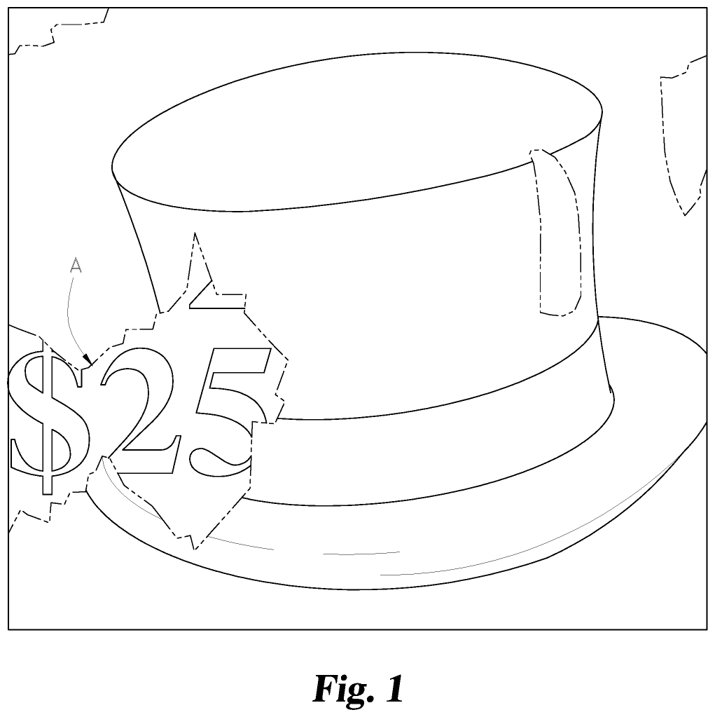

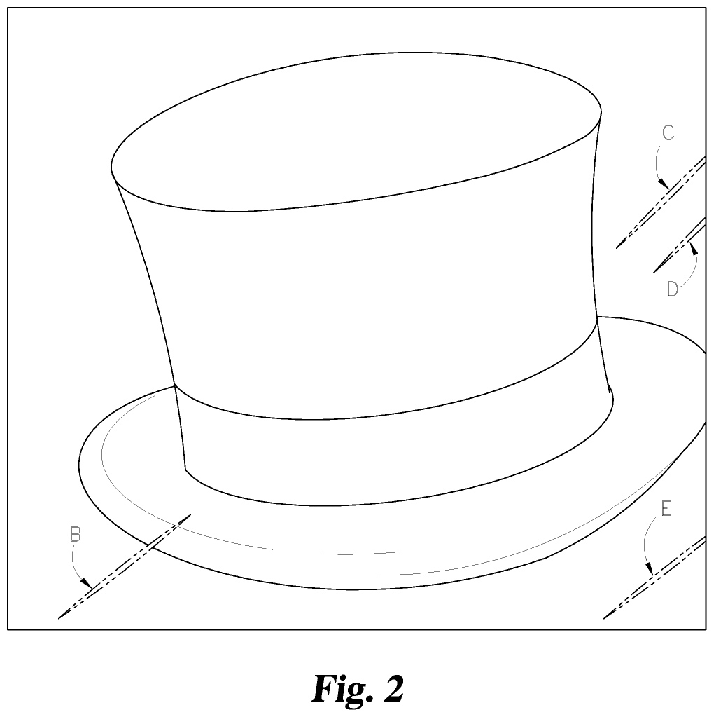

To illustrate these differences in scratching levels, reference is made to FIGS. 1 and 2. FIG. 1 is a diagram representing a portion of a game play area of a first scratch-off instant lottery ticket. In FIG. 1, a sufficient area (area A) of the total scratch-off area has been removed to reveal game play information readable to a person (i.e., that the ticket is a “winner” as it may have a redemption value of at least $25). Also, in this example, the scratched-off area is in a position within the game play area that reveals game play information indicating that the ticket is a winner. FIG. 2 is a diagram representing a portion of a game play area of a second scratch-off instant lottery ticket, having a similar exterior appearance as that of the first ticket in FIG. 1. In FIG. 2, small scratched-off areas appear in the lower left corner of FIG. 2 (area B) and along the right side of the image (areas C, D, E). FIG. 2 provides an example of the sort of incidental scratching that fails to reveal a sufficient amount of game play information to indicate whether the ticket is a winner or a loser.

In order to ensure fair play, the lottery administrator must make an assessment of how much game play information must be revealed before a ticket is disqualified from activation. The assessment parameters must be established and be consistently applied to facilitate the sale of instant tickets. If a large number of tickets with incidental, unintentional scratches (e.g., tickets such as that shown in FIG. 2) are invalidated, the removal of these tickets from the lottery game could cause the instant ticket game odds to change (because winning tickets may be invalidated and removed from circulation). Further, if a significant number of winning tickets are removed from circulation, one or more of those tickets could have been assigned a top-tier prize. In such a case, the lottery may face challenges in maintaining trust with their players. Additionally, there is a cost to the lottery associated with discarding tickets that would otherwise have been sold. The cost is likely a combination of the lost sale as well as the cost to print the ticket. Over time, these business losses and other damages could be substantial if all tickets with text revealed are removed from circulation.

Thus, there is a need to establish a quantifiable, consistent, autonomous decision-making platform for assessing scratching levels on instant tickets.

Due to the aforementioned scenarios, the inventor has developed an automated instant ticket inspection and activation system that provides a tool allowing a lottery administrator to set a preferred level of acceptable indicia revealed under scratches. The system provides for inspection in an objective, quantifiable, consistent, and autonomous decision-making platform. Such a system is useful to reduce a significant number of the losses mentioned above while also allowing the liability associated with the subjective decision of “how much indicia revealed is too much?” to rest with the lottery administrative board, rather than with the system provider.

The inventor has developed improved methods, systems, and devices for autonomous inspection of instant tickets, to be employed as part of the process of inspection, activation, voiding, validation, and payout of instant tickets. For accurate detection of tampering, embodiments of the method, system, and device provide for an effective inspection process that detects not only removal of the coating (e.g., scratches made in a scratch-off coating) on an instant ticket, but also identifies any presence of the indicia originally intended to be covered by the scratch-off coating. Further, if underlying indicia is detected, the system may, in an embodiment, objectively measure the level of presence or the volume of indicia revealed by a scratch.

In embodiments of the invention, the method, system, and device may preferably manipulate the outputs of machine learning-based, instant ticket inspection systems, such that a training dataset may be used to establish a classification threshold that allows a user to instantly make changes to how training data is classified without the need to manually reclassify data. Such a threshold may be used as a consistent threshold when autonomously determining the validity or sell-ability of an inactive instant ticket.

In an embodiment, an autonomous instant ticket inspection system may classify images of instant tickets into three categories; unscratched, scratched and scratched with text. In initial iterations, there may be inconsistencies with classifications between “scratched” and “scratched with text” such that, when processed through a vision machine learning model, an image of the same scratch may be classified differently upon subsequent scans. Additional or reorganized training data is one possible solution to this type of problem. However, the process is arduous and if performed, the results will still generate inconsistent results (albeit less frequently).

This inconsistency is unacceptable in certain operational environments such as lottery or banking where six sigma standards prevail. Consistency is essential and if a ticket is invalid on one scan, it must still be invalid on the next and subsequent scans.

Object classification, object localization and object detection software may perform functions that are based on or derived from human vision. In some cases, a human selects the training data (in this case, images) used to program the software to recognize specific objects. Such data should be representative of or closely resemble the use case or “real-world” data that the system will be asked to process. If the training data lacks examples closely resembling use cases, the software will not be able to generate an accurate prediction and will therefore assign the respective image with a low precision value. Consequently, in certain environments, there will often be cases where identification, localization or classification of an image may not occur on a consistent or accurate basis—as is the case with human vision.

In a machine learning environment, model accuracy is generally conditioned by the volume of data or instances in the training dataset. However, there are cases where increased training data ceases to improve the accuracy of the models. One explanation for this is when the training data does not closely resemble the use-case data with which the machine learning software is expected to function. For example, a machine learning model may be trained to recognize apples with a high degree of precision. However, if an apple is represented in an image by only a few pixels or if the apple is mostly hidden by another object, the software may fail to deliver the requisite level of precision and consistency thereby limiting the usefulness of the machine learning application.

Additionally, there may be times when a classification system must be retrained to output a different result using the same or similar data. Often, this is accomplished by either generating additional data or re-organizing data that already exists. In either case, data generation and data analysis are slow processes.

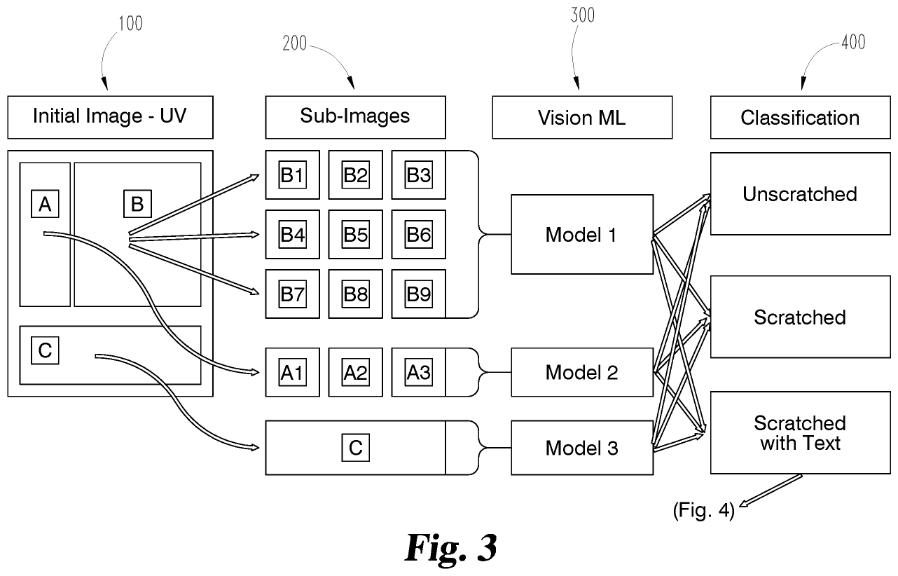

In view of the foregoing, the inventor has developed an improved method, system, and/or device. With reference to FIG. 3, herein is described an exemplary embodiment of the method, system and/or device.

In embodiments of the method and systems employing the method, a ticket set-up is performed to gather data needed in order to be able to scan a new style of scratch-off lottery ticket that is to be sold. Before a newly-released style of ticket can be scanned in a retail environment for the purposes intended herein, the system needs to be programmed to recognize, inspect and approve or reject the sale of the new ticket. In an embodiment, prior to retail deployment, using specially-programmed computer systems and software, a system administrator of a lottery system will generate scanned images of the new style of ticket and specially program the system to manage the inspection, activation and sale of that new ticket. With respect to the current subject matter, this involves the step of iterative scanning of a number of instant tickets having a given configuration (i.e., a given outward printed appearance including unscratched game play areas). A sufficient number of the instant tickets of a given style or configuration must be iteratively scanned to generate a base model of the image of a ticket of the given configuration. The instant tickets that are scanned may contain variable amounts of incidental scratching that is encountered in ordinary handling. Thus, the base model that is generated will provide an indicator of an acceptable level of ordinary incidental scratching that may be tolerated in the inspection system. The scanning described herein may preferably be accomplished by exposing the surfaces of the tickets to ultraviolet (UV) radiation and making electronic records of UV absorption/reflection patterns to compile a base model of the image. Other known image scanning devices and methodology may be used.

In an embodiment of a method, process, or system for new ticket setup, a removal step may be conducted in which an operator or administrator operating the system removes all of the latex/scratch-off coating on a series or plurality of sample copies of tickets of the new style.

In an embodiment, an operator using specially programmed computer or software and/or devices may use the computer, software, and/or devices to perform the following steps. The operator, after the removal step, may then conduct a scan step, scanning the plurality of sample copies of the tickets (with latex removed). The operator may conduct a capture and store step to capture and store the data files of two images of the tickets, one image of the front of the ticket and one image of the back of the ticket.

In an embodiment, the operator may conduct a code identification and assignment step to identify and scan a unique marking on each ticket, and assign that mark to the respective style of ticket and its database of commands/functions. In subsequent scans, the system then will recognize the style of ticket and associate the mark with the respective programs/software functions.

In an embodiment, the operator may conduct a boundary creation step to create boundary boxes for each visual game play object that previously had been hidden underneath the latex coating.

In an embodiment, the operator may conduct a boundary box grouping step to group the boundary boxes according to the image/s that was/were on the latex coating atop each hidden object. This step is represented in box 100 of FIG. 3 In a sub-image parsing step, sub-images may be parsed from the original image of the front of the ticket according to object/indicia present. This sub-image parsing step is represented in box 200 of FIG. 3. For example, boxes “B” may all have images of gold bars on the latex coating, boxes “A” may contain dollar signs and box “C” may contain text. Each unique object on the latex coating is assigned its own classification model in order to increase the accuracy of the overall results. This classification is represented in box 300 of FIG. 3.

In an embodiment, the operator may conduct a training scan step. Using tickets with the latex intact and tickets having test scratches applied intentionally so as to represent various stages of and levels of being scratched, the operator may scan a large number of sample tickets having latex intact and tickets having various representative levels of scratching. The training scan may be used to create “training” data to program, set, and assign the needed classification models. A large number of scans may be made in the training stage. The large number of scans may be used to generate a large number of sub-images, as represented in FIG. 3.

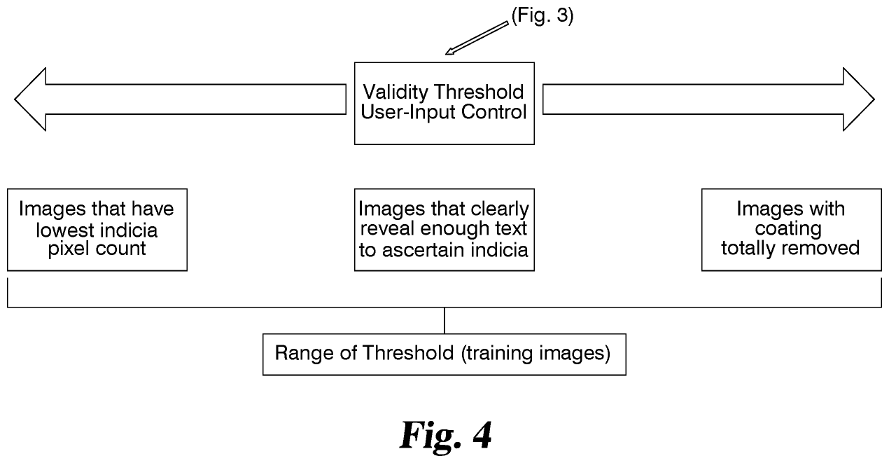

In an embodiment, after generating a large number of sub-images, the operator may conduct an image classifying/tagging step, wherein the operator may classify/tag images into one of a plurality of classifications. In an example as represented in FIG. 4, three classifications may be established, such as unscratched, scratched and scratched with text showing. In an embodiment, the classify/tag step may be conducted using a computer, software, or system employing artificial intelligence (AI) models, techniques, programs, platforms, or systems.

In an embodiment, an auditing step may be conducted wherein the classify/tag step may be conducted wherein the outcomes of this process, in the form of the reliability and reproducibility of consistent results, may be tested. The audit step may be automated by employing the specially programmed computer, software and/or system. The audit step optionally may be partially-automated, wherein, in an example, a human may “audit” the outcomes of the process to test the outcomes of the process to confirm production of accurate and consistent results.

In an embodiment, the classifying/tagging step may result in a set of “classed” images that are categorized in their respective groups.

In an embodiment, in an uploading step, the classed images may be uploaded in their respective groups to a vision classification model. In an embodiment, the vision classification model is a feature of the specially programmed computer, software, or system. In an embodiment, the vision classification model is a feature of a commercially available system, and optionally may employ systems utilizing artificial intelligence models or techniques.

In an embodiment, each set of classed images will use a unique model in order to get the highest level of precision possible in recognition of future scans of tickets for activation purposes.

The preceding steps constitute the training steps of the method and system.

After the training portion of the process has been conducted, the operator may verify the accuracy and precision of the models by conducting a model testing step. The model testing step may include testing the system accuracy by scanning a plurality of sample tickets with the latex unscratched, and scanning a plurality of sample tickets having varying levels of scratching. The scan also may include scanning a plurality of sample tickets having the latex totally removed. If the system consistently classifies images into the proper categories with a high confidence interval, the models are considered tested, and ready for commercial application. If the system makes errors, one or more of the training steps may be repeated on an iterative basis, wherein the operator may continue scanning tickets and uploading images until the system generates accurate and consistent results.

In an embodiment, the method, system, and/or device may be specially programmed to comply with user preferences. In an example of an embodiment, a lottery or lottery administrator may have preferences on a level of scratching that may be tolerated and yet the ticket still considered to be sellable and eligible for activation. In an example, an operator of the system may confirm with the lottery administrator the administrator's preferences with respect to scratching tolerance levels for a particular style of ticket that has been set up for use using the training steps. Specifically, using specially programmed computers, software, and/or devices, the lottery administrator may set a selected threshold at which tickets are considered good/sellable or bad/unsellable. For example, a first lottery administrator may choose to allow no hidden text to be revealed in order for a ticket to be considered sellable and eligible for activation. In contrast, a second lottery administrator may choose to activate a ticket even where a small (or certain given) amount of text below the latex coating is visible due to scratching.

Regardless of the amount of underlying text revealed, a visually-quantifiable level must be selected, then set and applied to all future activations/sales. Thus, this invention represents an improvement over the current method of allowing a retailer or the consumer to make this decision. For instance, with the existing method, an unsuspecting customer could purchase a scratch-off ticket from a retailer who has already checked (by scratching or otherwise) if the ticket is a winner prior to sale. This happens frequently with the current method because most consumers don't have time to inspect the authenticity of a ticket while they're causing a bottleneck at the cash register in the convenience store.

FIG. 4 is a diagram representing a visual user interface of the threshold function, whereby the lottery administrator may see a visual representation of each classification in order to aid the administrator's selection of its preferred level of scratching that will be tolerated before a ticket is ineligible for sale and activation.

In an embodiment, after the models are trained, tested and functional by reason of applying the training steps outlined above, an organization step may be conducted wherein all of the images classified in a particular grouping (for example, a grouping tagged as “scratched with text”) are organized in either ascending or descending order according to the amount of hidden text revealed. The amount of hidden text revealed may be measured relative to a percentage of the overall boundary box containing the hidden content. The amount may, in an embodiment, also be measured using a pixel count, or any other quantifiable and consistent measurement technique.

In an embodiment, the now-organized images may be used as the content for a visual user interface (UI). The visual user interface may allow the user to scroll through the organized range of images, arranged in ascending/descending order according to the amount of scratching and/or the amount of hidden text that is revealed under the scratched area. In an embodiment, in a selection step, the user may view a particular image in the dataset that appears to reveal “too much” hidden text. In the selection step, the user may select that image, thereby establishing the maximum (or minimum, depending on the selected parameter) threshold for all future images that are classified as “scratched with text”. With such an example of the system, all subsequent scans in a retail environment will be processed using this threshold. If a ticket scan reveals hidden text under a scratch in excess of the level selected and set by the lottery administrator, the software would not activate the ticket for sale. As such, the decision to activate a ticket is fully-automated, consistent and fair—an improvement over the existing methods that are subject to a variety of schemes intended to defraud the customer and/or the lottery and ultimately the state in which that lottery operates.

In an embodiment, the selection of a threshold may be represented by a “slider” function as depicted in FIG. 4. In an example, a “slider” may present a visual representation of a scratched ticket, allowing the user to visually inspect and compare images in order to select the threshold in the manner of a slider representing ascending/descending levels of scratching. The slider presentation may include a reading of given scratch level parameters, such as the percentage of a given image that has been scratched away, a number of pixels scratched away vs. intact, or other quantifiable measurement of a scratching level. In an example of this embodiment, a user may select one of the images to select the threshold at which the user determines that volume of text that is revealed a selected scratching tolerance level.

In an embodiment, a sector rule-setting step may be performed. For example, a lottery administrator may apply sector rules to set selected tolerance rules to a given sector of the ticket image. Such a method and system may be programmed such that, if any particular selected sector contains a scratch with text that exceeds the established threshold that had been set for that particular selected sector, the entire ticket would be invalidated and not activated, regardless of levels of scratching found on other sectors. In an example, the method/system may be programmed such that one threshold applies to one sector and another threshold applies to another sector. The latter example could be more useful depending upon the game play characteristics of the ticket.

In an embodiment, where a ticket or ticket style has been set up in the system, the directions for inspection may then be disseminated and stored within the computer system of every ticket scanning outlet in the field, such as the retail sales locations. This localized data processing may increase system speed to achieve the shortest processing time possible for every future retail transaction involving the sale of the set-up ticket. After receiving the data file for the respective ticket, each unit in the field is then capable of performing the retail transaction by discerning whether each individual scanned ticket is sellable and eligible for activation.

In an embodiment, the method, system, and/or device may be employed in actual ticket sales. In an example, the particular ticket has been set up using the training steps and optionally the slider function steps, and the inspection directions have been disseminated to the field units. In a ticket sale process, there may be steps comprising:

A ticket is inserted into scanner in a retail environment; the scanner generates images of the ticket; a processor onboard the scanner parses the ticket image (see FIG. 3, box 100) as originally directed during the setup process, and generates a number of sub-images (see FIG. 3, box 200). The images are processed through their respective classification model (see FIG. 3, box 300). The classification models then assign a class to each scanned image (see FIG. 3, box 400). In an example, the scanning of images result in finding images that fall into the class “scratched with text.” In this example, such images are then evaluated against the validity threshold (see FIG. 4) established by the lottery administrator during the ticket setup process. If the threshold/s established during ticket setup are breached, the ticket will not be activated in the system and the ticket will be rejected as unsellable.

With respect to prior art, it has been determined that scanning apparatus and software, without adequate training, may behave inconsistently when making determinations concerning ticket surface images that are difficult to classify, yielding difficult classification events. For example, with respect to images that contain a scratch, certain scratches create a deposit or build-up of the scratch-off coating along the edge of a scratch. These deposits can be visually similar to the text under the scratch-off coating (e.g., both black). In these cases, software may be software programmed to determine a choice on whether the image appears to have text, or not. Sometimes the determination in the difficult classification event is correct, and sometimes the determination is not. Because of this inconsistency, the invention may be employed consistently with the method described above to apply an additional layer of classification that takes the aforementioned difficult classification events, and groups them according to pre-determined rules. This secondary classification would apply to images that fall into the “scratched with text” primary classification and break them out further into either “valid” or “invalid.”

Identifying, selecting, and quantifying the amount, type, content, or importance of matter that is revealed by the scratching away of the coating is a decision that may vary according to a number of parameters, reflecting the policies and judgment of the particular lottery in question. The determination may have human or subjective elements. The parameters affecting the decision of what will constitute an invalid ticket is, by nature, subjective. As such, the decision must be made by the administering lottery. Therefore, the operation of the inspection system is improved by the tool that has been developed by the inventor, that allows the lottery, via an authorized user, to choose and apply an acceptable threshold.

The tool provided under the instant invention is in the nature of a “slider” as shown in the upper portion of FIG. 4 that, when set on the low end, invalidates tickets that have scratches that reveal any text whatsoever, and if set on the high end, allows all of the text under the scratch coating to be revealed before the respective ticket will be determined to be invalid. In an example, a lottery employing the slider tool would choose a setting somewhere in the middle, where smaller, incidental scratches are allowed and ignored, and so the ticket is valid and saleable, and where larger, more obvious scratches would cause the ticket to be determined to be invalid.

Thus, in embodiments, a system and method is provided for establishing an adjustable threshold at which scratch-off lottery tickets would be considered invalid (and therefore unavailable for sale) due to an unacceptable amount of text showing under an area of the ticket that has been scratched. In embodiments, a system and method is provided that allows a user of a vision machine-learning algorithm the ability to customize the classification of digital images which, after being initially processed through a machine learning classification system, are processed further to generate a second, additional layer of classification based on user input/criteria. The user input/criteria may reflect or be determined in accord with a setting selected by a user as in the slider of FIG. 4, that represents a level of tolerance for scratches that reveal a selected volume of indicia, such as a selected volume of exposed text.

Embodiments of the present method, system, and/or device of the present invention offer new and unexpected improvement to operations of instant ticket lottery management systems, that has not been offered by the prior art. The new instantaneously updated ticket-by-ticket inspection data will allow an instant ticket lottery system to compile, access, assess, and apply real-time tampering data for instant lottery tickets, as well as levels and types of incidental scratching data. The system thus enables the selection, application, and optimization of thresholds of incidental scratching data in a manner useful to help automate, and enhance consistency in, the determination of whether a given ticket is valid or invalid. An additional improvement is to enable user input to set or adjust levels and parameters for types of shown content that will be tolerated during inspections, and/or amounts of scratched-off area that will be tolerated during inspections.

Thus, disclosed is a method, system and device for inspection of a lottery ticket that uses a device to scan lottery tickets to detect information concerning the amount of scratch-off material, such as a coating or a covering, that has been removed from a ticket, and/or the type, amount, or substantive content of underlying indicia that have been revealed by the scratches. The system may use the information to calculate and set or determine a tolerance level for scratching below which a ticket will not be invalidated, based on parameters that may include the amount of surface area that has been scratched. In embodiments, the parameters may include recognition of content revealed by analysis of images captured in the scanning process. In embodiments, the type, amount, or substantive content of underlying indicia that has been revealed may be parameters used to determine thresholds or tolerance levels. The system enables a user to input information to reset the threshold values or tolerance levels above which invalidation is triggered, based on user parameters. User parameters may include, for example, types of indicia revealed, substantive content of indicia revealed (pictures, shapes, numerals, lettering), amount of indicia revealed, and the sector of the ticket revealed.

There is disclosed herein a method for inspection of a lottery ticket, the method comprising: using a device adapted to communicate information to a specifically-programmed computer system to: scan surfaces of a plurality of tickets to generate a set of image data; generate scratch status information based on the set of image data; and communicate the image data and the scratch status information to the computer system, wherein the computer system localizes respective areas of the image data where the scratch status information indicates that underlying indicia are revealed, isolates the underlying indicia found within respective areas of localization, measures the underlying indicia found, to determine a volume of indicia revealed, determines a threshold volume of indicia revealed, above which invalidation is triggered, and compares the volume of indicia revealed in the lottery ticket to the threshold volume of indicia.

The measuring of the underlying indicia found may be conducted by assessing a pixel count. The method may comprise generating a linear representation of data representing the volume of indicia revealed. User input may reset the threshold based on user-selected parameters.

There is disclosed a system for inspection of a lottery ticket, the system comprising: a specifically-programmed computer system, and a device adapted to communicate information to the computer system, the device being configured and adapted to: scan surfaces of a plurality of tickets to generate a set of image data; generate scratch status information based on the set of image data; and communicate the image data and the scratch status information to the computer system, wherein the computer system is adapted and configured to: localize respective areas of the image data where the scratch status information indicates that underlying indicia are revealed, isolate the underlying indicia found within respective areas of localization, measure the underlying indicia found, to determine a volume of indicia revealed, determine a threshold volume of indicia revealed, above which invalidation is triggered, and compare the volume of indicia revealed in the lottery ticket to the threshold volume of indicia.

There is disclosed a device for inspection of a lottery ticket, the device comprising: a specifically-programmed computer system, and a scanning apparatus adapted to communicate information to the computer system, the scanning apparatus being configured and adapted to: scan surfaces of a plurality of tickets to generate a set of image data; generate scratch status information based on the set of image data; and communicate the image data and the scratch status information to the computer system, wherein the computer system is adapted and configured to: localize respective areas of the image data where the scratch status information indicates that underlying indicia are revealed, isolate the underlying indicia found within respective areas of localization, measure the underlying indicia found, to determine a volume of indicia revealed, determine a threshold volume of indicia revealed, above which invalidation is triggered, and compare the volume of indicia revealed in the lottery ticket to the threshold volume of indicia.

The system, device, and method offer unexpected improvements to operations of the instant ticket gaming systems that have not been offered by the prior art. First, a new higher level of accountability and trust in the ticket inspection system may be established by employing the invention to reduce the level of subjective judgment in assessment of excessive scratching levels prior to sale. The system provides a trained, tested set of comparison image models, offering high levels of objectivity in deciding whether a scratch-off ticket has too much of its game play indicia revealed and thus cannot be validly activated and sold. Second, instant ticket inspection tasks heretofore have not enjoyed the benefit of the user-controlled validity threshold as illustrated in FIG. 4. The system allows control by lottery administrators of thresholds for levels of pre-sale scratching in relation to the particular configurations and characteristics of particular lottery ticket types, shapes, and sizes. Even while retaining an overall objective, consistent, defensible standard for scratch inspection, the lottery administrator can adjust validity thresholds. The thresholds may be advantageously adjusted to account for differences in ticket handling conditions, and differences in ticket configurations. For example, certain ticket shapes or coating compositions might be more susceptible to incidental and harmless scratching that should not prevent ticket activation and sale.

While the invention is described in terms of inspecting instant tickets, the invention also may be applied to improve other inspection functions, for example, for improvement of inspection tasks such as inspecting paper documents other than lottery tickets, or inspecting plastic or metal articles of manufacture for defects or wear.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention, and that different specific embodiments disclosed herein can be recombined to provide other embodiments not explicitly shown or described. Accordingly, all such modifications are intended to be included within the scope of this disclosure as defined in the following claims. It should be understood that while the use of words such as preferable, preferably, preferred or more preferred utilized in the description above indicate that the feature so described may be more desirable, it nonetheless may not be necessary, and embodiments lacking the same and excluding the same also may be contemplated as within the scope of the invention. In some instances, exclusion of particular features is considered by the inventors to form an inherent part of the invention, necessary to the provision of the benefits of improved simplicity and cost-effectiveness that arise out of exclusion of the particular features from the claimed invention. The above-described embodiments of the present invention have been provided to illustrate various aspects of the invention. However, it is to be understood that different aspect of the invention shown in different specific embodiments can be combined to provide other embodiments of the invention.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method for inspection of a lottery ticket, the method comprising:
using a device adapted to communicate information to a specifically-programmed computer system to:
scan surfaces of a plurality of tickets to generate a set of image data;
generate scratch status information based on the set of image data; and
communicate the image data and the scratch status information to the computer system, wherein the computer system
localizes respective areas of the image data where the scratch status information indicates that underlying indicia are revealed,
isolates the underlying indicia found within respective areas of localization,
measures the underlying indicia found, to determine a volume of indicia revealed, determines a threshold volume of indicia revealed, above which invalidation is triggered, and
compares the volume of indicia revealed in the lottery ticket to the threshold volume of indicia.

2. The method according to claim 1, wherein the measuring the underlying indicia found is conducted by assessing a pixel count.

3. The method according to claim 1, comprising generating a linear representation of data representing the volume of indicia revealed.

4. The method according to claim 1, wherein user input resets the threshold based on user-selected parameters.

5. A system for inspection of a lottery ticket, the system comprising:
a specifically-programmed computer system, and a device adapted to communicate information to the computer system, the device being configured and adapted to:
scan surfaces of a plurality of tickets to generate a set of image data;
generate scratch status information based on the set of image data; and
communicate the image data and the scratch status information to the computer system, wherein the computer system is adapted and configured to:
localize respective areas of the image data where the scratch status information indicates that underlying indicia are revealed,
isolate the underlying indicia found within respective areas of localization,
measure the underlying indicia found, to determine a volume of indicia revealed,
determine a threshold volume of indicia revealed, above which invalidation is triggered, and
compare the volume of indicia revealed in the lottery ticket to the threshold volume of indicia.

6. A device for inspection of a lottery ticket, the device comprising:
a specifically-programmed computer system, and a scanning apparatus adapted to communicate information to the computer system, the scanning apparatus being configured and adapted to:
scan surfaces of a plurality of tickets to generate a set of image data;
generate scratch status information based on the set of image data; and
communicate the image data and the scratch status information to the computer system, wherein the computer system is adapted and configured to:
localize respective areas of the image data where the scratch status information indicates that underlying indicia are revealed,
isolate the underlying indicia found within respective areas of localization,
measure the underlying indicia found, to determine a volume of indicia revealed,
determine a threshold volume of indicia revealed, above which invalidation is triggered, and
compare the volume of indicia revealed in the lottery ticket to the threshold volume of indicia.
